(19) United States
(12) Patent Application Publication
(10) Pub. No.: US 2018/0157114 A1
(43) Pub. Date: Jun. 7, 2018

(54) REFLECTIVE LIQUID CRYSTAL DEVICE

(71) Applicant: Samsung Display Co., Ltd., Yongin-si (KR)

(72) Inventors: Seunghyun PARK, Seoul (KR); Junho Song, Seongnam-si (KR)

(21) Appl. No.: 15/826,681

(22) Filed: Nov. 30, 2017

(30) Foreign Application Priority Data
Dec. 1, 2016 (KR) 10-2016-0162794
Jul. 13, 2017 (KR) 10-2017-0088921

(51) Int. Cl. G02F 1/1335; G02F 1/1333

(52) U.S. Cl. CPC G02F 1/133553; G02F 1/133514; G02F 1/133512; G02F 2203/02; G02F 2201/123; G02F 2001/133314; G02F 2203/30; G02F 1/133308

(57) ABSTRACT

A reflective LCD device is capable of measuring a cell-gap even after an attachment process of an LCD panel includes: a first substrate including a display area and a non-display area around the display area; a second substrate opposing the first substrate; a liquid crystal layer disposed between the first substrate and the second substrate; and a plurality of pixels disposed on the first substrate. The plurality of pixels includes: a plurality of first pixels disposed on the display area and each of the plurality of first pixels including a reflective layer; and at least one second pixel not including the reflective layer.

### CROSS-REFERENCE TO RELATED APPLICATIONS

This application claims priorities from and the benefit of Korean Patent Applications No. 10-2016-0162794, filed on Dec. 1, 2016, and Korean Patent Applications No. 10-2017-0088921, filed on Jul. 13, 2017, which are hereby incorporated by reference for all purposes as if fully set forth herein.

### BACKGROUND

### Field

Exemplary embodiments relate to a reflective liquid crystal display (“LCD”) display device. More particularly, exemplary embodiments relate to a reflective LCD display device capable of easily measuring a cell-gap.

### Discussion of the Background

Recently, display devices displaying an image using an LCD panel, a plasma display panel (“PDP”) panel, an electroluminescence display panel, and an organic light emitting diode (“OLED”) display panel have been garnering attention.

LCD devices include an LCD panel and displays an image by adjusting liquid crystal arrangement to adjust the transmittance of light. Such an LCD device is a display device which cannot generate light by itself. Accordingly, transmissive LCD devices include a backlight assembly which provides a light to the LCD panel. However, the backlight assembly is thick, heavy and consumes a lot of power.

Display devices capable of being driven with low power consumption includes a reflective LCD device. The reflective LCD device displays an image by adjusting the transmittance of light by reflecting natural light or external artificial light. Accordingly, the reflective LCD device is lighter than the transmissive LCD device and consumes less power.

In conventional reflective LCD devices, a reflective layer for reflecting natural light or external artificial light is disposed over an entire surface of an LCD panel, resulting in a problem where it is hard to measure a cell-gap in a post process after, for example, a substrate attachment process.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a reflective LCD device in which a reflective layer is omitted in some areas in order to efficiently measure a cell-gap.

Additional aspects will be set forth in the detailed description which follows, and, in part, will be apparent from the disclosure, or may be learned by practice of the inventive concept.

According to an exemplary embodiment, a reflective LCD device is capable of measuring a cell-gap even after an attachment process of an LCD panel includes: a first substrate including a display area and a non-display area around the display area; a second substrate opposing the first substrate; a liquid crystal layer disposed between the first substrate and the second substrate; and a plurality of pixels disposed on the first substrate. The plurality of pixels includes: a plurality of first pixels disposed on the display area and each of the plurality of first pixels including a reflective layer; and at least one second pixel not including the reflective layer.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a plan view illustrating a reflective LCD device according to a first exemplary embodiment.

FIG. 2 is a plan view illustrating a reflective LCD device according to a second exemplary embodiment.

FIG. 3 is an enlarged view illustrating an area “A” of FIG. 1.

FIG. 4A is a plan view illustrating a wiring portion of FIG. 3.

FIG. 4B is a plan view illustrating a reflective layer of FIG. 3.

FIG. 4C is a plan view illustrating the reflective layer and the wiring portion of FIG. 3.

FIG. 4D is a plan view illustrating a color filter of FIG. 3.

FIG. 4E is a plan view illustrating a black matrix and a column spacer of FIG. 3.

FIG. 5 is a cross-sectional view taken along the line I-I′ of FIG. 3.

FIG. 6 is a cross-sectional view taken along the line II-II′ of FIG. 3.

FIG. 7 is a plan view illustrating a reflective LCD device according to a third exemplary embodiment.

FIG. 8 is a plan view illustrating a reflective LCD device according to a fourth exemplary embodiment.

FIG. 9 is a plan view illustrating a reflective LCD device according to a fifth exemplary embodiment.

FIG. 10 is an enlarged view illustrating an area “B” of FIG. 9.

FIG. 11A is a plan view illustrating a wiring portion of FIG. 10.

FIG. 11B is a plan view illustrating a reflective layer of FIG. 10.

FIG. 11C is a plan view illustrating the reflective layer and the wiring portion of FIG. 10.

FIG. 11D is a plan view illustrating a color filter of FIG. 10.

FIG. 11E is a plan view illustrating a black matrix and a column spacer of FIG. 10.

FIG. 12 is a cross-sectional view taken along the line of FIG. 10.

FIG. 13 is a cross-sectional view taken along the line IV-IV′ of FIG. 10.

FIG. 14 is a plan view illustrating a reflective LCD device according to a sixth exemplary embodiment.

FIG. 15 is an enlarged view illustrating an area “C” of FIG. 14.

FIG. 16 is a plan view illustrating a reflective LCD device according to a seventh exemplary embodiment.

FIG. 17 is an enlarged view illustrating an area “D” of FIG. 16.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

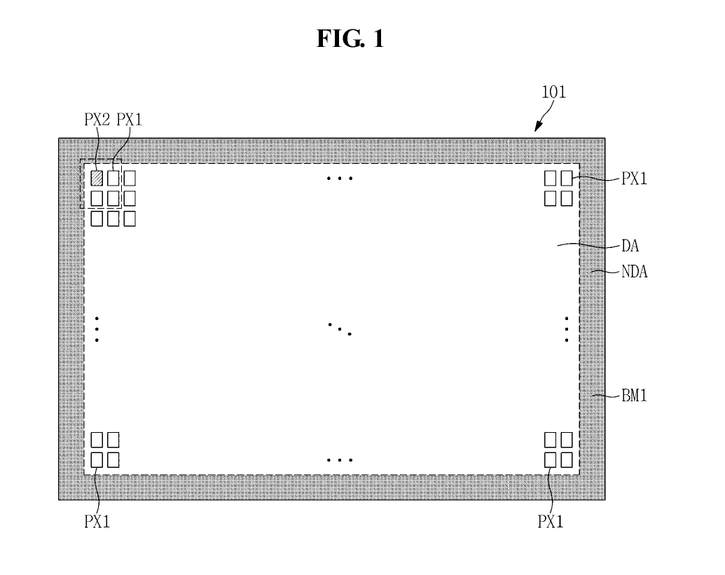

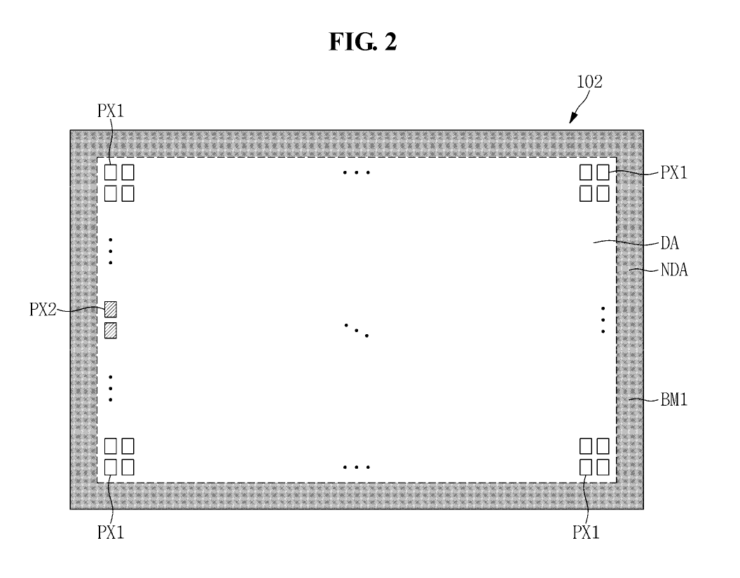

FIG. 1 is a plan view illustrating a reflective LCD device according to a first exemplary embodiment and FIG. 2 is a plan view illustrating a reflective LCD device according to a second exemplary embodiment.

Referring to FIGS. 1 and 2, each of the reflective LCD device 101 according to a first exemplary embodiment and the reflective LCD device 102 according to a second exemplary embodiment includes a display area DA and a non-display area NDA around the display area DA.

Each of the reflective LCD device 101 according to a first exemplary embodiment and the reflective LCD device 102 according to a second exemplary embodiment includes a plurality of pixels PX1, PX2 disposed at the display area DA and a first black matrix BM1 at the non-display area NDA.

The first pixel PX1 collectively refers to pixels including a reflective layer (not illustrated) and the second pixel PX2 collectively refers to pixels not including a reflective layer (not illustrated).

The first pixel PX1 may be disposed at most of an area of the display area DA and the second pixel PX2 may be disposed at a corner portion of the display area DA (see FIG. 1) or an edge portion of the display area DA (see FIG. 2).

The second pixel PX2 may include at least one second pixel, and a plurality of pixels may be disposed adjacent to each other or the plurality of pixels may be disposed spaced apart from each other.

Since an area at which the second pixel PX2 is disposed does not include a reflective layer (not illustrated), a cell-gap may be measured even after an attachment process of an LCD panel.

The second pixel PX2 represents a black gray level when the LCD device is driven in practice, and is not used for displaying an image. Accordingly, the second pixel PX2 may be disposed at a corner portion or an edge portion of the display area DA, but exemplary embodiments are not limited thereto. In an exemplary embodiment, the second pixel PX2 may be disposed at an arbitrary area in the display area DA.

Hereinafter, the reflective LCD device according to the first exemplary embodiment will be described in which the second pixel PX2 is disposed at the corner portion of the display area DA.

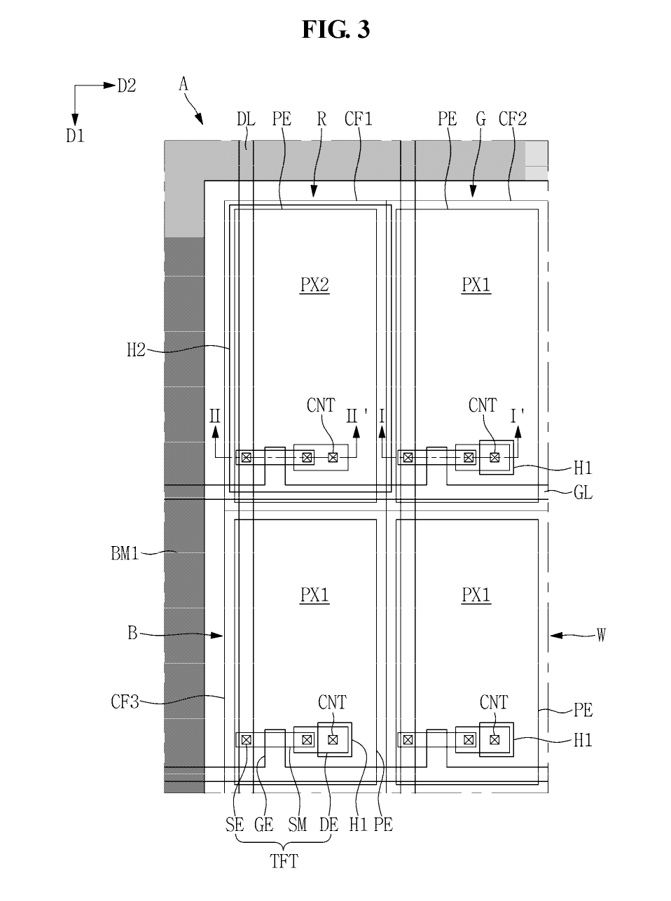

FIG. 3 is an enlarged view illustrating an area “A” of FIG. 1.

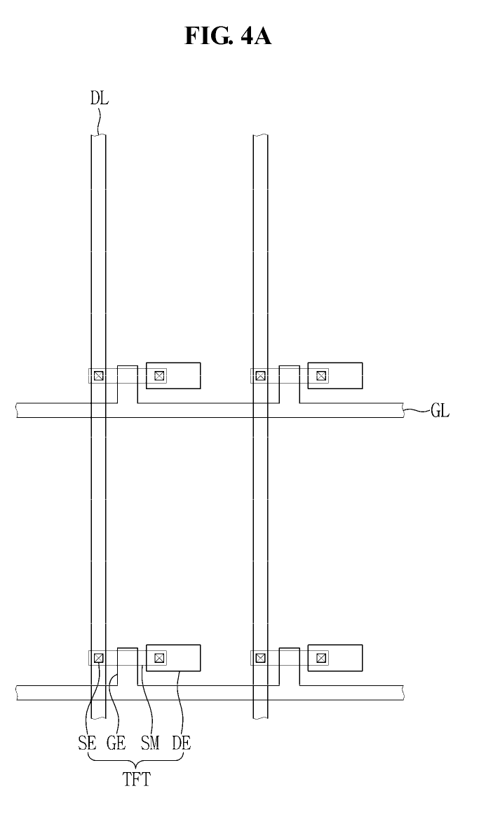

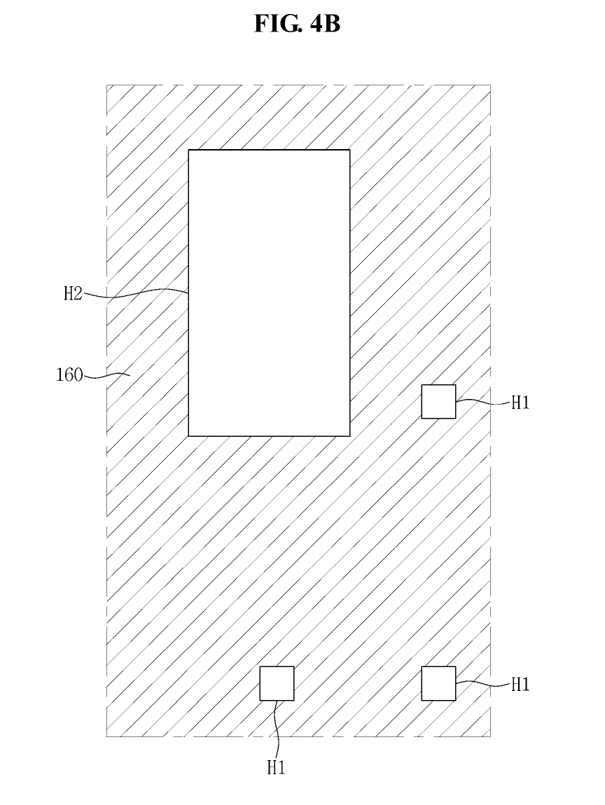

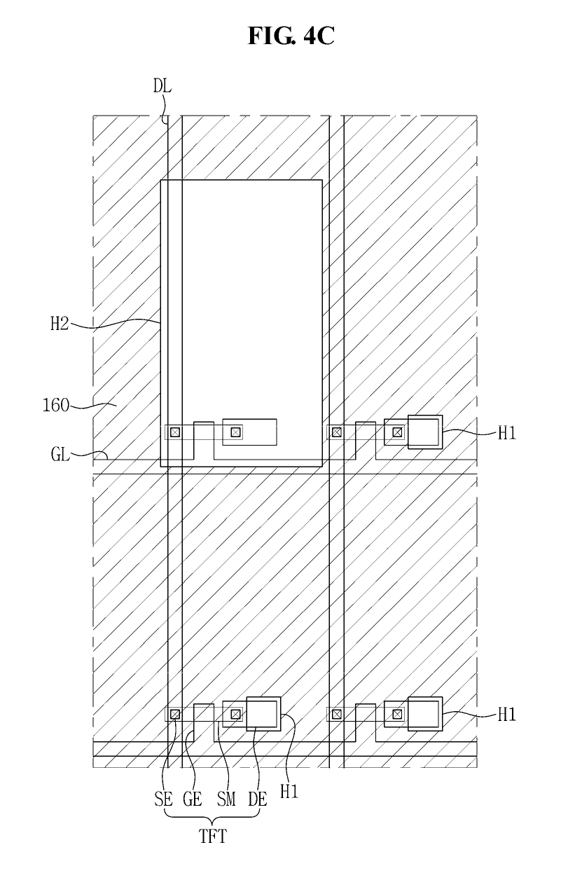

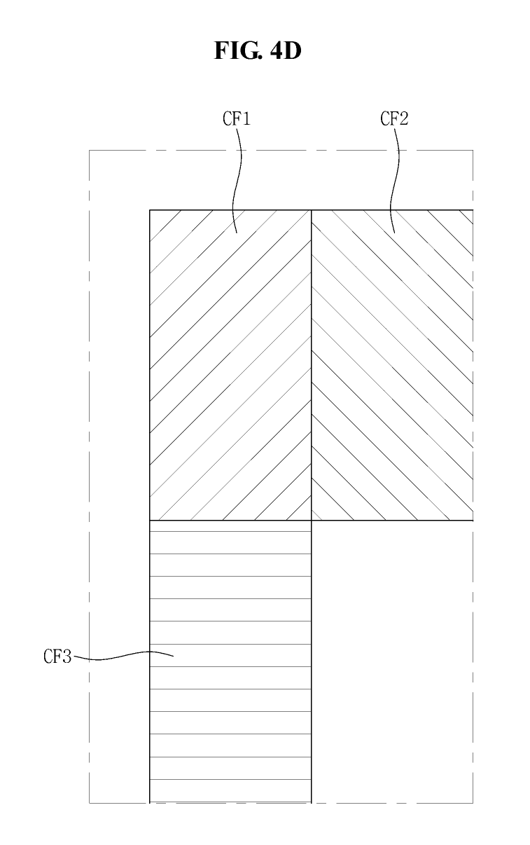

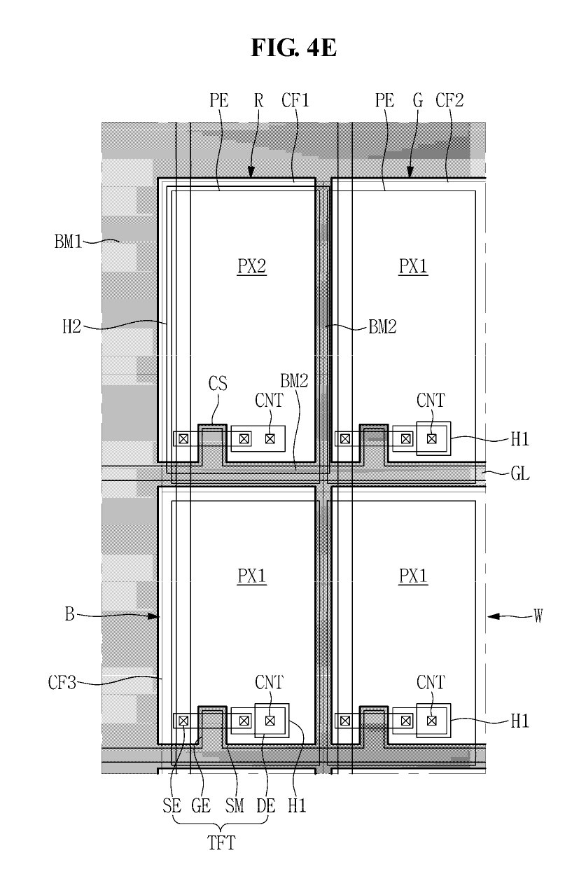

FIG. 4A is a plan view illustrating a wiring portion of FIG. 3, FIG. 4B is a plan view illustrating a reflective layer of FIG. 3, FIG. 4C is a plan view illustrating the reflective layer and the wiring portion of FIG. 3, FIG. 4D is a plan view illustrating a color filter of FIG. 3 and FIG. 4E is a plan view illustrating a black matrix and a column spacer of FIG. 3.

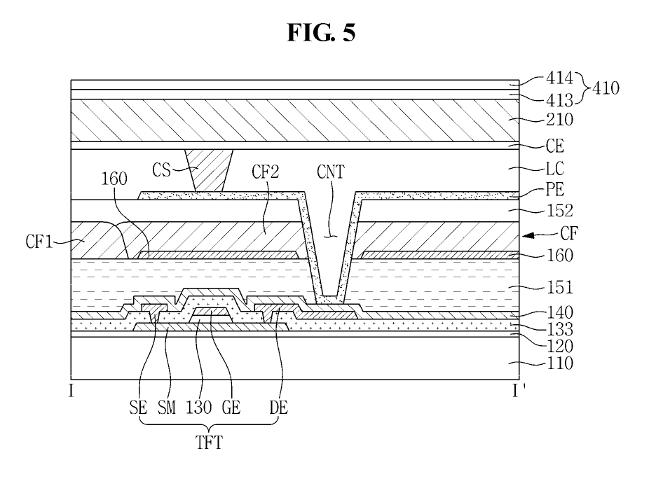

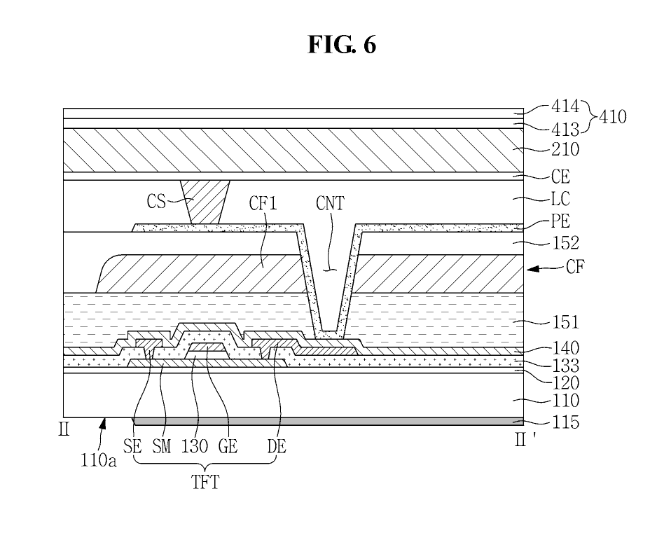

FIG. 5 is a cross-sectional view taken along the line I-I′ of FIG. 3 and FIG. 6 is a cross-sectional view taken along the line II-II′ of FIG. 3.

Referring to FIGS. 3, 4, 5, and 6, the reflective LCD device 101 according to a first exemplary embodiment includes a first substrate 110, a second substrate 210 opposing the first substrate 110 and a liquid crystal layer LC between the first substrate 110 and the second substrate 210.

The first substrate 110 may include a display area DA and a non-display area NDA around the display area DA. The plurality of pixels PX1 and PX2 may be disposed at the display area DA, the first pixel PX1 may be disposed at most of an area of the display area DA and the second pixel PX2 may be disposed at a corner portion of the display area DA. The first pixel PX1 may include a reflective layer 160 to be described below and the second pixel PX2 may not include the reflective layer 160.

The first substrate 110 may include an insulating material selected from the group consisting of; glass, quartz, ceramic, plastic, or the like. A buffer layer 220 may be disposed on the first substrate 110. The buffer layer 220 may include one or more layers selected from various inorganic layers and organic layers. The buffer layer 220 may be omitted.

A semiconductor layer SM may be disposed on the buffer layer 120. The semiconductor layer SM may include amorphous silicon, polycrystalline silicon, or the like. The semiconductor layer SM may include an oxide semiconductor.

A gate insulating layer 130 may be disposed on the semiconductor layer SM and a gate electrode GE is disposed on the gate insulating layer 130. The gate insulating layer 130 may be disposed over an entire surface of the first substrate 110 or may be disposed only at an area overlapping the gate electrode GE. In FIGS. 5 and 6, the gate insulating layer 130 may be disposed at an area overlapping the gate electrode GE.

The gate electrode GE extends from the gate line GL.

An insulating interlayer 133 may be disposed on the gate electrode GE. The insulating interlayer 133 may include an insulating organic layer or an insulating inorganic layer.

A source electrode SE and a drain electrode DE may be disposed on the insulating interlayer 133. The source electrode SE and the drain electrode DE may be spaced apart from each other and each of the source electrode SE and the drain electrode DE overlaps a portion of the semiconductor layer SM. Each of the source electrode SE and the drain electrode DE may be connected to the semiconductor layer SM through a contact hole defined in the insulating interlayer 133.

Referring to FIGS. 3 and 4A, a part of the data line DL becomes the source electrode SE. The drain electrode DE may be electrically connected to the pixel electrode PE through a contact hole CNT.

The data line DL may cross the gate line GL. Hereinafter, a direction in which the data line DL extends may be referred to as a first direction D1 and a direction in which the gate line GL extend is referred to as a second direction D2.

The gate electrode GE, the semiconductor layer SM, the source electrode SE, and the drain electrode DE may constitute a TFT. The structure of the TFT disclosed in FIGS. 3, 5, and 6 may also be referred to as a top gate structure. However, a first exemplary embodiment is not limited thereto and the TFT may have a bottom gate structure.

A portion including the gate line GL, the data line DL, and the TFT may be referred to as a wiring portion. Since the wiring portion may drive pixels, it may also be referred to as a driving unit. The wiring portion is illustrated in FIG. 4A.

A passivation layer 140 may be disposed on the source electrode SE and the drain electrode DE. The passivation layer 140 may protect the wiring portion.

A first protective layer 151 may be disposed on the passivation layer 140. The first protective layer 151 may be a single layer or a multilayer including an organic layer or an inorganic layer. According to a first exemplary embodiment, the first protective layer 151 is an organic layer. Either the passivation layer 140 or the first protective layer 151 may be omitted.

Referring to FIGS. 3, 4B, and 4C, the reflective layer 160 is disposed over an entire surface of the first protective layer 151. The reflective layer 160 may be disposed at an area overlapping at least the pixel electrode PE. The reflective layer 160 may include a metal. For example, the reflective layer 160 may include a reflective layer including aluminum (Ag) or silver (Ag).

The reflective layer 160 may be insulated from the TFT. The reflective layer 160 may be disposed at an area other than an area corresponding to the contact hole CNT and other than an area corresponding to the second pixel PX2. Referring to FIG. 4B, the reflective layer 160 may have a first opening H1 and a second opening H2. The first opening H1 may be defined at an area corresponding to the contact hole CNT of the first pixel PX1 and the second opening H2 may be defined at an area corresponding to the second pixel PX2.

That is, the first pixel PX1 may include the reflective layer 160 and the second pixel PX2 does not include the reflective layer 160. A uniform voltage may be applied across the reflective layer 160.

Referring to FIGS. 3 and 4D, a color filter layer CF may be disposed on the reflective layer 160. The color filter layer CF may include a first color filter CF1, a second color filter CF2, and a third color filter CF3. The first color filter CF1, the second color filter CF2, and the third color filter CF3 may have different colors, respectively, and may each be one of a red color filter, a green color filter, and a blue color filter.

According to a first exemplary embodiment, the first color filter CF1 is a red color filter and corresponds to a red pixel R. The second color CF2 may be a green color filter and corresponds to a green pixel G. The third color filter CF may be a blue color filter and corresponds to a blue pixel B.

In addition, the reflective LCD device 101 according to a first exemplary embodiment may include a white pixel W. A color filter may not be disposed on a portion of the reflective layer 160 corresponding to the white pixel W. However, a first exemplary embodiment is not limited to this and a white filter may be disposed at the white pixel W. The color filters CF1, CF2, and CF3 may not be disposed at an area of the contact hole CNT of the first pixel PX1 and an area of the contact hole CNT of the second pixel PX2.

According to a first exemplary embodiment, a portion at which two different color filters meet is referred to as a boundary portion and two color filters may overlap each other or may be spaced apart from each other at the boundary portion.

A second protective layer 152 may be disposed on the color filter layer CF. The second protective layer 152 may be a single layer or a multilayer including an organic layer or an inorganic layer. The second protective layer 152 may include a material substantially the same as a material included in the first protective layer 151.

A part of the first protective layer 151 and the second protective layer 152 may be removed to define the contact hole CNT exposing a portion of the drain electrode DE.

The pixel electrode PE may be disposed on the second protective layer 152. The pixel electrode PE may include a transparent conductive oxide (TCO) such as ITO, IZO or AZO.

The pixel electrode PE may overlap the reflective layer 160 and may be arranged in units of pixel. The pixel electrode PE may be electrically connected to the drain electrode DE through the contact hole CNT.

Since the pixel electrode PE overlaps the reflective layer 160, in the case where an electric potential of the reflective layer 160 changes, an electric potential of the pixel electrode PE may also change due to the coupling with the reflective layer 160. For example, in the case where the electric potential of the reflective layer 160 is unstable, a riffle may occur at the electric potential of the pixel electrode PE. Such a riffle may cause flickering in the screen.

Accordingly, according to a first exemplary embodiment, the reflective layer 160 may be insulated from the pixel electrode PE and may be connected to a terminal (not illustrated) having a predetermined electric potential. For example, the reflective layer 160 may be connected to a ground terminal (not illustrated). However, a first exemplary embodiment may be not limited thereto and the reflective layer 160 may be connected to another terminal having a constant electric potential.

The second substrate 210 may be disposed to oppose the first substrate 110 and the liquid crystal layer LC may be interposed between the first substrate 110 and the second substrate 210.

A common electrode CE may be disposed on the second substrate 210. The common electrode CE may oppose the pixel electrode PE and may include a transparent conductive oxide (TCO) such as ITO, IZO or AZO.

A column spacer CS supporting the first substrate 110 and the second substrate 210 may be disposed between the first substrate 110 and the second substrate 210. A gap between the pixel electrode PE and the common electrode CE, that is, a cell-gap, may be kept constant by the column spacer CS.

Referring to FIGS. 3 and 4E, black matrices BM1 and BM2 may be disposed on the second substrate 210. The black matrices BM1 and BM2 may be disposed on the common electrode CE.

The black matrices BM1 and BM2 may include a first black matrix BM1 at an area corresponding to the non-display area NDA and a second black matrix BM2 at the boundary portion between pixels.

The black matrices BM1 and BM2 and the column spacer CS may be unitary.

The column spacers CS may be disposed overlapping the TFT.

In addition, a polarizing plate 410 may be disposed on the second substrate 210. The polarizing plate 410 is disposed on the side of the second substrate 210 opposite to the common electrode CE.

The polarizing plate 410 may include a polarizer 414 and a retardation plate 413 on the polarizer 414. When the polarizer 410 is attached to the second substrate 210, the retardation plate 413 may be disposed closer to the liquid crystal layer LC than the polarizer 414 is thereto.

The polarizer 414 may linearly polarize an external light incident to the polarizing plate 410.

For example, a film that is formed by orienting dichroic dyes on a PVA resin in an absorption manner may be used as the polarizer 414. Examples of the PVA resin may include a homopolymer of vinyl acetate or a copolymer of vinyl acetate with other monomers.

The retardation plate 413 may be disposed on a surface of the polarizer 414.

The retardation plate 413 retards a phase of the light. The retardation plate 413 may convert linearly polarized light into circularly polarized light, or may convert circularly polarized light into linearly polarized light. For example, a light externally incident to the polarizing plate 410 may be linearly polarized by the polarizer 414 and circularly polarized by the retardation plate 413. The circularly polarized external light may be reflected in the LCD device 101 and then may be emitted outwards through the polarizing plate 410 or fail to propagate through the polarizing plate 410 and dissipate.

The retardation plate 413 may have a film shape. The retardation plate 413 may include a quarter wave plate (“QWP”). The kind of and method of manufacturing the QWP are not particularly limited. Any suitable products that are currently available may be used as the QWP according to exemplary embodiments.

A light control film (“LCF,” not illustrated) may be disposed on a surface of the retardation plate 413. The LCF may have light directivity to control a path of external light or reflected light and diffuse the reflected light to improve light efficiency.

The reflective LCD device 101 according to a first exemplary embodiment displays images using a natural light or an external light that is incident thereto. For example, a natural light or an external light incident to the LCD device 101 is reflected from the reflective layer 160 and then transmitted through the color filter layer CF and the liquid crystal layer LC such that an image may be displayed. The polarizing plate 410 may control the incident light or the reflected light reflected by the reflective layer 160 so that the LCD device 101 may display an image.

In the reflective LCD device 101 according to a first exemplary embodiment, the first pixel PX1 includes the reflective layer 160 and the second pixel PX2 does not include the reflective layer 160. Thus, a cell-gap may be measured even after an attachment process through an area at which the second pixel PX2 is disposed. In addition, since the second pixel PX2 does not display images while the first pixel PX1 displays images through control of the liquid crystal layer LC, the second pixel PX2 may only represent a black gray level during the drive.

In addition, referring to FIG. 6, a black sheet 115 may be further disposed on another surface 110a of the first substrate 110 that does not face the second substrate 210. The black sheet 115 may be disposed only at an area corresponding to the second pixel PX2.

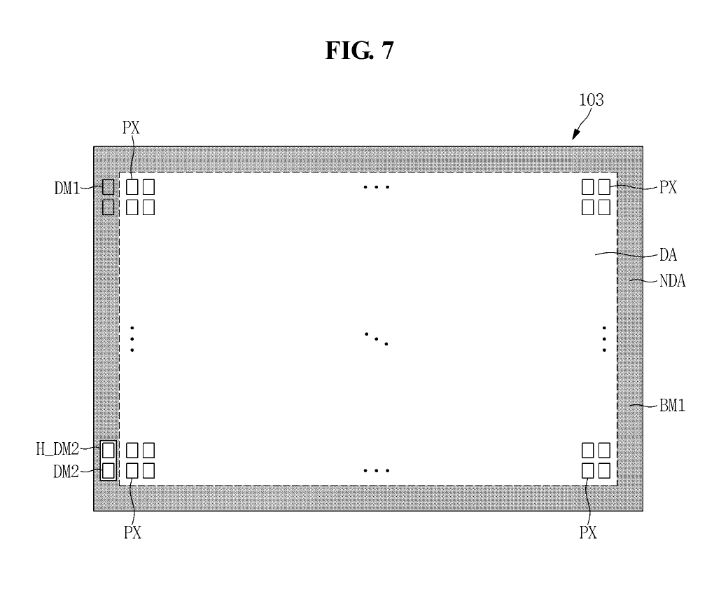

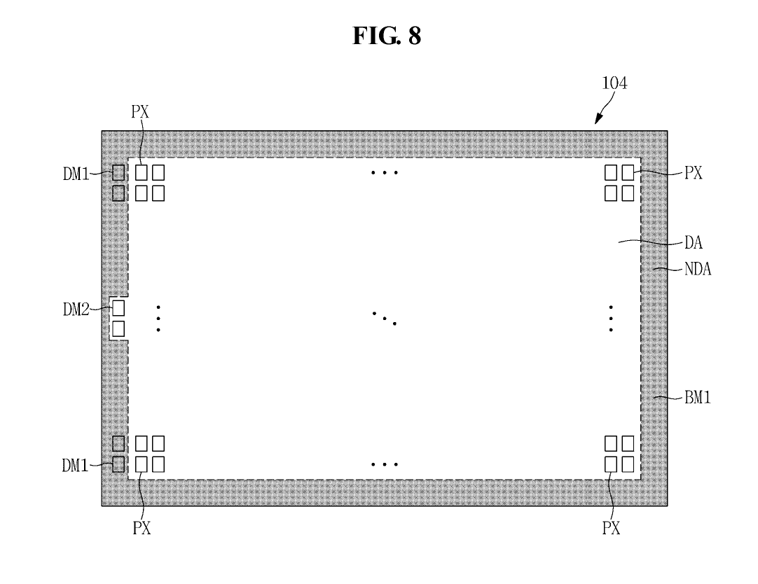

FIG. 7 is a plan view illustrating a reflective LCD device according to a third exemplary embodiment and FIG. 8 is a plan view illustrating a reflective LCD device according to a fourth exemplary embodiment. The descriptions of the reflective LCD device according to the first exemplary embodiment will be omitted from the descriptions of the reflective LCD device according to third and fourth exemplary embodiments.

Referring to FIGS. 7 and 8, each of the reflective LCD device 103 according to the third exemplary embodiment and the reflective LCD device 104 according to the fourth exemplary embodiment includes a display area DA and a non-display area NDA around the display area DA.

Each of the reflective LCD device 103 according to the third exemplary embodiment and the reflective LCD device 104 according to the fourth exemplary embodiment may include a plurality of first pixels PX1 at the display area DA; a plurality of first dummy pixels DM1 and a plurality of second dummy pixels DM2, which are second pixels PX2, at the non-display area NDA; and a first black matrix BM1 at the non-display area NDA.

The dummy pixels DM1 and DM2 at the non-display area NDA may be pixels for discharging static electricity generated during the manufacturing process and not actual pixels for displaying images. That is, the dummy pixels DM1 and DM2 may be configured to substantially minimize damage caused by the static electricity or the like generated in the pixel PX at the display area DA during the manufacturing process.

The plurality of pixels PX at the display area DA and the first dummy pixel DM1 at the non-display area NDA may include a reflective layer (not illustrated), whereas the second dummy pixel DM2, which is the second pixel PX2, is disposed at the non-display area NDA and may not include a reflective layer (not illustrated).

The second dummy pixel DM2 may be arranged at an arbitrary area in the non-display area NDA. For example, the second dummy pixel DM2 may be disposed adjacent to a corner portion of the non-display area NDA (see FIG. 7) or an edge portion of the non-display area NDA (see FIG. 8).

The second dummy pixel DM2 may include at least one second pixel, and a plurality of pixels may be disposed adjacent to each other or the plurality of pixels may be disposed spaced apart from each other.

The first black matrix BM1 may be disposed on the non-display area NDA overlapping the first dummy pixel DM1, whereas the first black matrix BM1 may be omitted on the non-display area NDA overlapping the second dummy pixel DM2.

For example, referring to FIG. 7, the first black matrix BM1 may have a cutout portion H_DM2 at an area corresponding to the second dummy pixel DM2 on a plane. Alternatively, the first black matrix BM1 may have a concavo-convex shape on a plane such that an area corresponding to the second dummy pixel DM2 may be exposed.

The second pixel PX2 may represent a black gray level when the LCD device is driven in practice, and is not used for displaying an image

Since an area at which the second dummy pixel DM2 is disposed may not include the reflective layer (not illustrated) and the first black matrix BM1, a cell-gap may be measured even after the attachment process of the LCD panel.

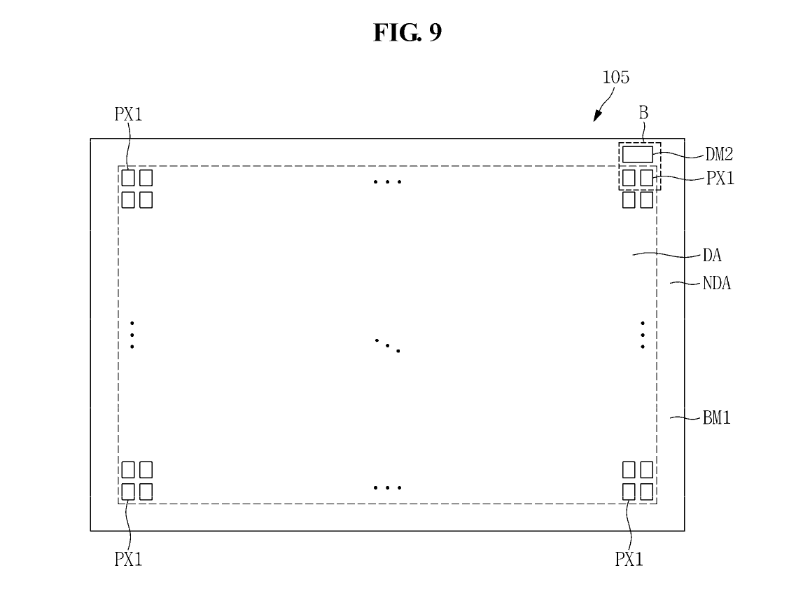

FIG. 9 is a plan view illustrating a reflective LCD device 105 according to a fifth exemplary embodiment.

Referring to FIG. 9, the reflective LCD device 105 according to a fifth exemplary embodiment includes a display area DA and a non-display area NDA around the display area DA.

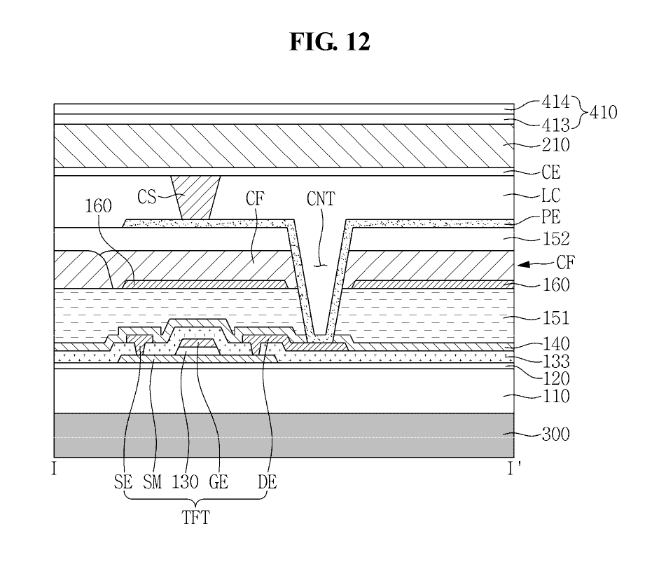

The reflective LCD device 105 according to a fifth exemplary embodiment includes a first pixel PX1 at a display area DA; a second dummy pixel PX2, which is a second pixel PX2, at a non-display area NDA; and a first black matrix BM1 at the non-display area NDA. In addition, the reflective LCD device 105 according to a fifth exemplary embodiment includes a bottom chassis 300 (see FIG. 12).

The first pixel PX1 collectively refers to pixels including a reflective layer (not illustrated). The first pixel PX1 may be disposed on most of the area of the display area DA.

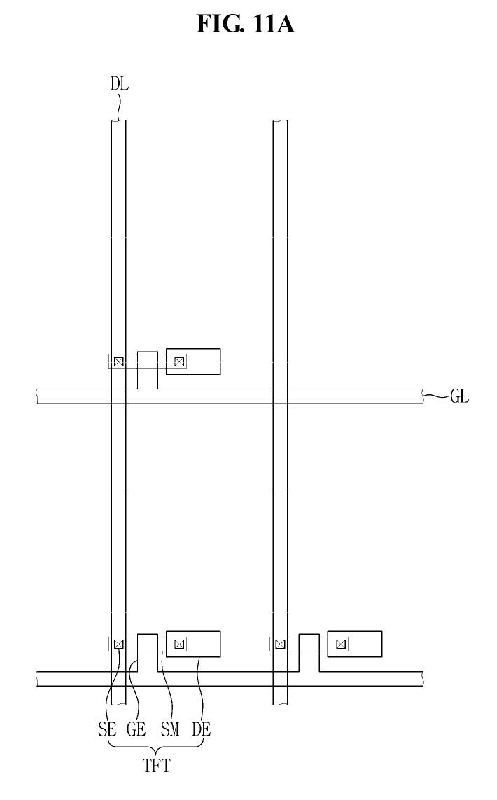

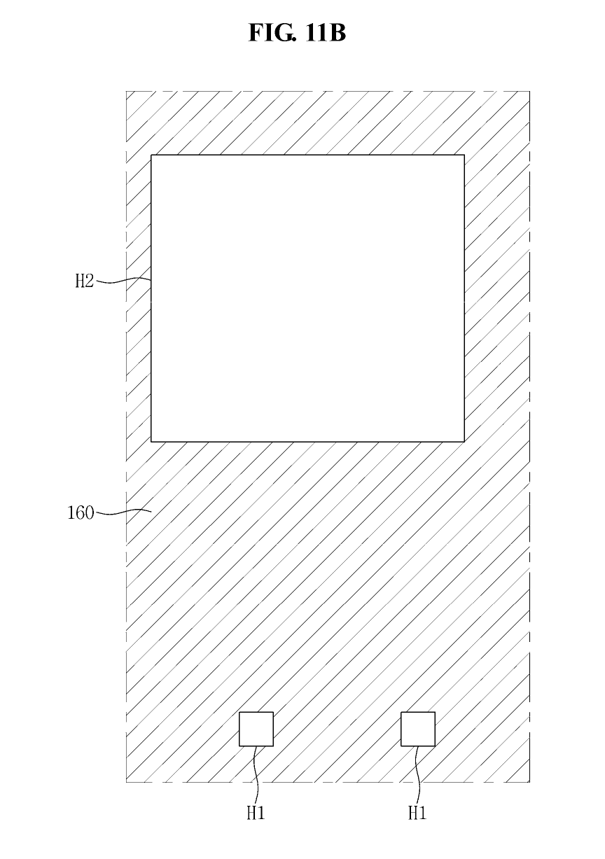

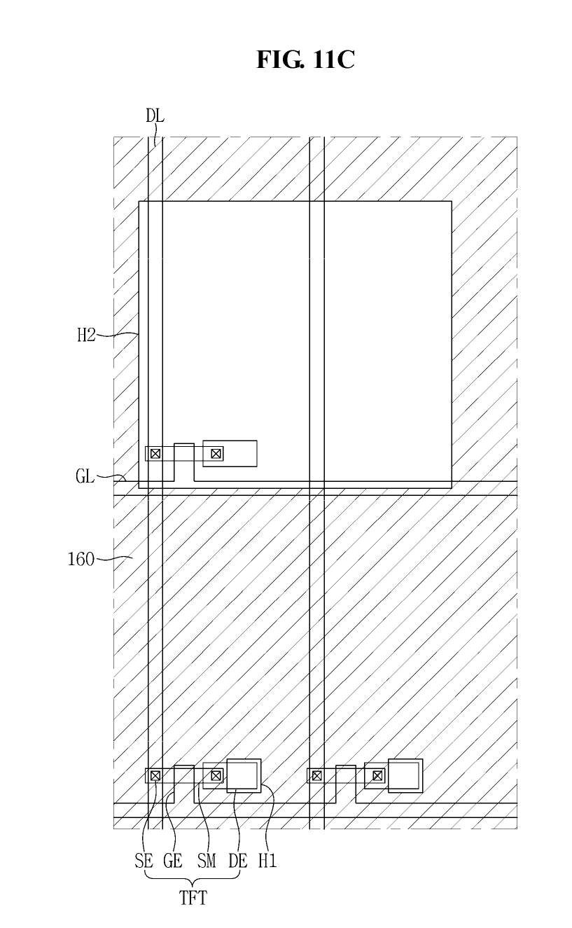

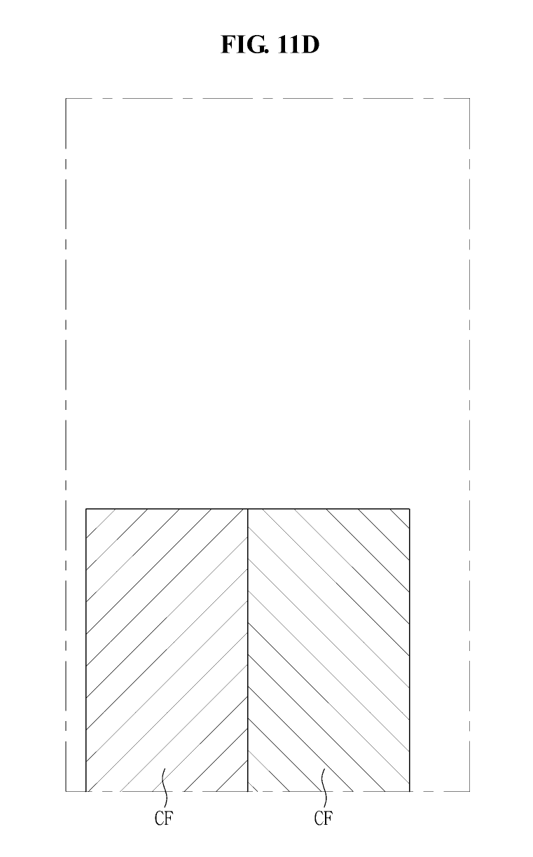

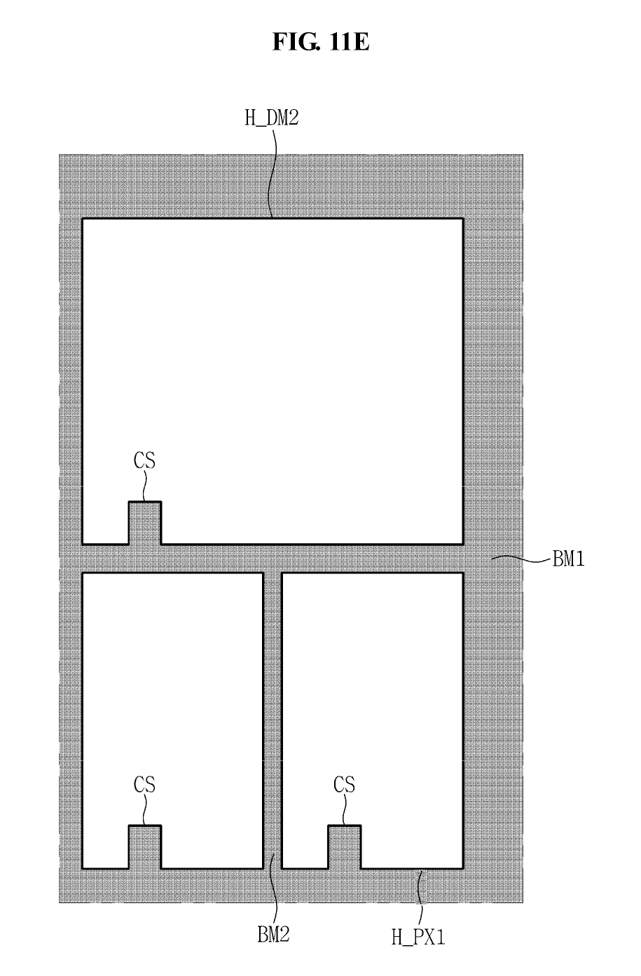

The first pixel PX1 may be defined by the black matrices BM1 and BM2. In other words, the black matrices BM1 and BM2 may have a first cutout portion H_PX1 (see FIG. 11E) which exposes the first pixel PX1.

The second dummy pixel DM2, which is the second pixel PX2, may collectively refer to pixels not including a reflective layer (not illustrated). The second dummy pixel DM2 may be disposed at an arbitrary area in the non-display area NDA. For example, the second dummy pixel DM2 may be disposed adjacent to a corner portion of the non-display area NDA or an edge portion of the non-display area NDA.

The reflective LCD device 105 according to a fifth exemplary embodiment includes at least one second dummy pixel DM2.

The first black matrix BM1 may have a second cutout portion H_DM2 (see FIG. 11E) which exposes at least one of the second dummy pixels DM2.

According to a fifth exemplary embodiment, the second cutout portion H_DM2 has a planar area substantially equal to or less than a planar area of a reflective portion 310 of a bottom chassis 300 to be described below. Accordingly, the display quality of the second dummy pixel DM2 may be improved.

As illustrated in FIG. 9, the second dummy pixel DM2 may have a size larger than a size of the first pixel PX1. The second dummy pixel DM2 may have a size corresponding to a size of two first pixels PX1. However, exemplary embodiments are not limited thereto and the second dummy pixel DM2 may have a size corresponding to a size of a plurality of first pixels PX1.

According to a fifth exemplary embodiment, the second dummy pixel DM2 may display a gray scale. For example, the second dummy pixel DM2 may display either a black gray level or a white gray level. Alternatively, the second dummy pixel DM2 may display a gray level. For example, the second dummy pixel DM2 may display an on/off state of the reflective LCD device 105, or may display a remaining battery power of the reflective LCD device 105. However, exemplary embodiments are not limited thereto.

Since an area at which the second dummy pixel DM2 may be disposed does not include the reflective layer (not illustrated) and the first black matrix BM1, a cell-gap may be measured after an attachment process of the LCD panel.

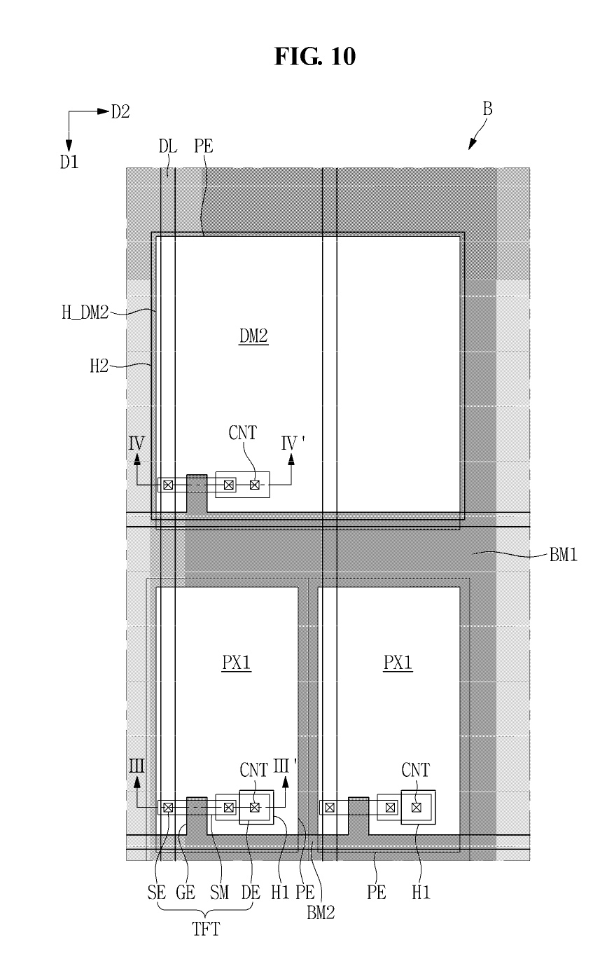

The bottom chassis 300 (see FIG. 12) will be described below in detail with reference to FIGS. 10, 11A, 11B, 11C, 11D, 11E, 12, and 13.

FIG. 10 is an enlarged view illustrating an area “B” of FIG. 9.

FIG. 11A is a plan view illustrating a wiring portion of FIG. 10, FIG. 11B is a plan view illustrating a reflective layer of FIG. 10, FIG. 11C is a plan view illustrating the reflective layer and the wiring portion of FIG. 10, FIG. 11D is a plan view illustrating a color filter of FIG. 10, and FIG. 11E is a plan view illustrating a black matrix and a column spacer of FIG. 10.

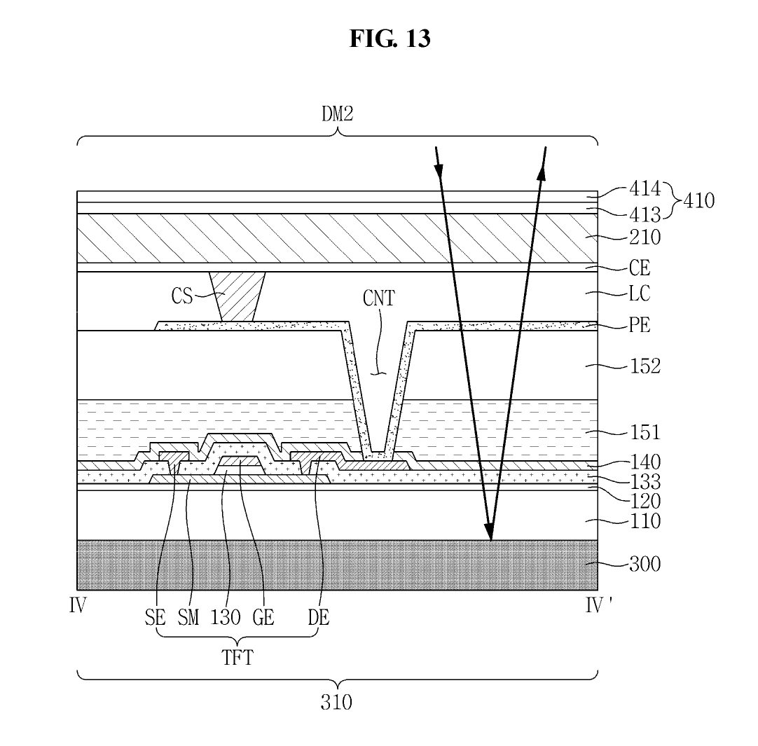

FIG. 12 is a cross-sectional view taken along the line of FIG. 10 and FIG. 13 is a cross-sectional view taken along the line IV-IV′ of FIG. 10.

Referring to FIGS. 10, 11A, 11B, 11C, 11D, 11E, 12, and 13, the reflective LCD device 105 according to a fifth exemplary embodiment includes the bottom chassis 300, a first substrate 110, a second substrate 210 opposing the first substrate 110 and a liquid crystal layer LC between the first substrate 110 and the second substrate 210.

The bottom chassis 300 may accommodate an LCD panel including the first substrate 110, the second substrate 210, and the liquid crystal layer LC. That is, the LCD panel including the first substrate 110, the second substrate 210, and the liquid crystal layer LC may be disposed on the bottom chassis 300.

According to a fifth exemplary embodiment, after an attachment process of the LCD panel, the LCD panel including the first substrate 110, the second substrate 210, and the liquid crystal layer LC may be accommodated in the bottom chassis 300.

The bottom chassis in which the LCD panel is disposed may include a reflective portion 310 at an area corresponding to the second dummy pixel DM2 which is the second pixel PX2. For example, the bottom chassis 300 may include a material capable of reflecting an external light at an area corresponding to the second dummy pixel DM2. For example, the bottom chassis 300 may include a metal at an area corresponding to the second dummy pixel DM2. In an exemplary embodiment, the bottom chassis 300 may include a unitary metal. Accordingly, external light incident through the LCD panel may be reflected by the reflective portion 310 of the bottom chassis 300, and thus the second dummy pixel DM2 may display an image based on a gray level voltage applied to the second dummy pixel DM2.

In addition, according to a fifth exemplary embodiment, the reflective portion 310 of the bottom chassis 300 has a planar area substantially equal to or larger than a planar area of the second cutout H_DM2 of the first black matrix BM1 and substantially equal to or larger than a planar area of the second opening H2 of a reflective layer 160 to be described below. Accordingly, the display quality of the second dummy pixel DM2 may be improved.

The first substrate 110 may include a display area DA and a non-display area NDA around the display area DA. The first pixel PX1 may be disposed at the display area DA. For example, the first pixel PX1 may be disposed at most of an area of the display area DA. The second dummy pixel DM2 may be disposed at an arbitrary area in the non-display area NDA. For example, the second dummy pixel DM2 may be disposed adjacent to a corner portion of the non-display area NDA or an edge portion of the non-display area DA. The first pixel PX1 may include the reflective layer 160, to be described below, and the second dummy pixel DM2 which is a second pixel PX2 that does not include the reflective layer 160.

Referring to FIGS. 10, 11B, 11C, and 12, the reflective layer 160 is disposed over an entire surface of the first protective layer 151. The reflective layer 160 may be disposed on an area overlapping the pixel electrode PE, which is disposed at the first pixel PX1. The reflective layer 160 may include a metal. For example, the reflective layer 160 may include a reflective layer including aluminum (Ag) or silver (Ag).

The reflective layer 160 may be insulated from the TFT. The reflective layer 160 may be disposed at an area other than an area corresponding to the contact hole CNT and other than an area corresponding to the second dummy pixel DM2. Referring to FIG. 11B, the reflective layer 160 has a first opening H1 and a second opening H2. The first opening H1 may be defined at an area corresponding to the contact hole CNT of the first pixel PX1 and the second opening H2 may be defined at an area corresponding to the second dummy pixel DM2.

According to a fifth exemplary embodiment, the second opening H2 has a planar area substantially equal to or less than a planar area of the reflective portion 310 of the bottom chassis 300 on a plane. In addition, the second opening H2 may have a planar area substantially equal to a planar area of the second cutout portion H_DM2 of the first black matrix BM1 on a plane. Accordingly, the display quality of the second dummy pixel DM2 may be improved.

According to a fifth exemplary embodiment, the first pixel PX1 may include the reflective layer 160 and the second dummy pixel DM2 may not include the reflective layer 160. Thus, a cell-gap may be measured through an area at which the second dummy pixel DM2 is disposed after an attachment process.

That is, the first pixel PX1 may include the reflective layer 160 and the second dummy pixel DM2 may not include the reflective layer 160. A uniform voltage may be applied across the reflective layer 160.

Referring to FIGS. 10 and 11D, a color filter layer CF is disposed on the reflective layer 160. Respective color filter layers CF of the first pixels PX1 may have different colors from each other and may be one of a red filter, a green filter, and a blue filter.

Referring to FIGS. 10, 11E, and 12, black matrices BM1 and BM2 are disposed on the second substrate 210. The black matrices BM1 and BM2 may be disposed on a common electrode CE. Alternatively, the black matrices BM1 and BM2 may be disposed on the first substrate 110 in a black matrix on array (BOA) structure which refers to a structure in which a color filter CF and black matrices BM1 and BM2 are arranged on a first substrate 110 on which a TFT is disposed.

The black matrices BM1 and BM2 may include a first black matrix BM1 at an area corresponding to the non-display area NDA and a second black matrix BM2 at a boundary portion between each pixel.

The black matrices BM1 and BM2 and a column spacer CS may be unitary. In such an exemplary embodiment, the black matrices BM1 and BM2 and the column spacer CS may be substantially simultaneously formed using a substantially same material. Such black matrices BM1 and BM2 and column spacer CS may also be referred to as a black column spacer BCS.

The column spacers CS may be disposed to overlap the thin film transistor TFT.

According to a fifth exemplary embodiment, the first pixel PX1 may include the reflective layer 160 and the second dummy pixel DM2 may not include the reflective layer 160. Thus, a cell-gap may be measured even after an attachment process through an area at which the second dummy pixel DM2 is disposed. In addition, according to a fifth exemplary embodiment, the first black matrix BM1 may have the second cutout portion H_DM2 defining the second dummy pixel DM2 and the bottom chassis 300 may include the reflective portion 310 at an area corresponding to the second dummy pixel DM2. Thus, the second dummy pixel DM2 may reflect an external light and display an image based on a gray level voltage applied to the second dummy pixel DM2.

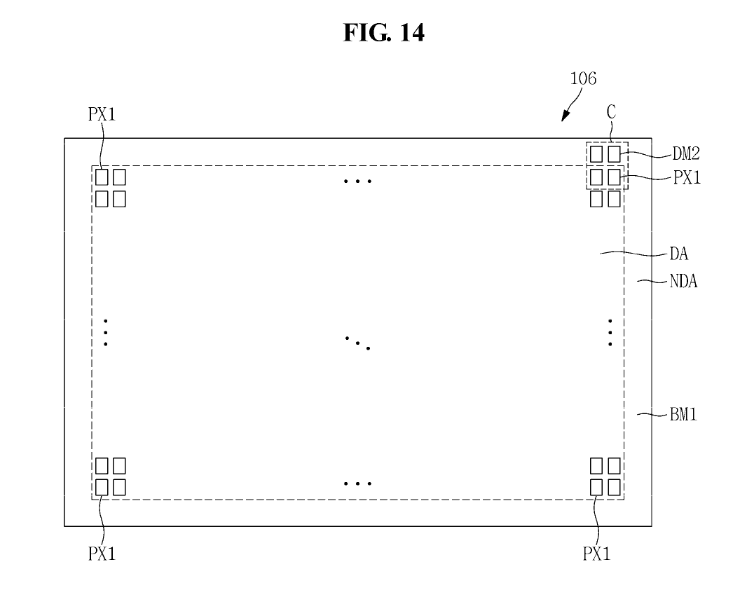

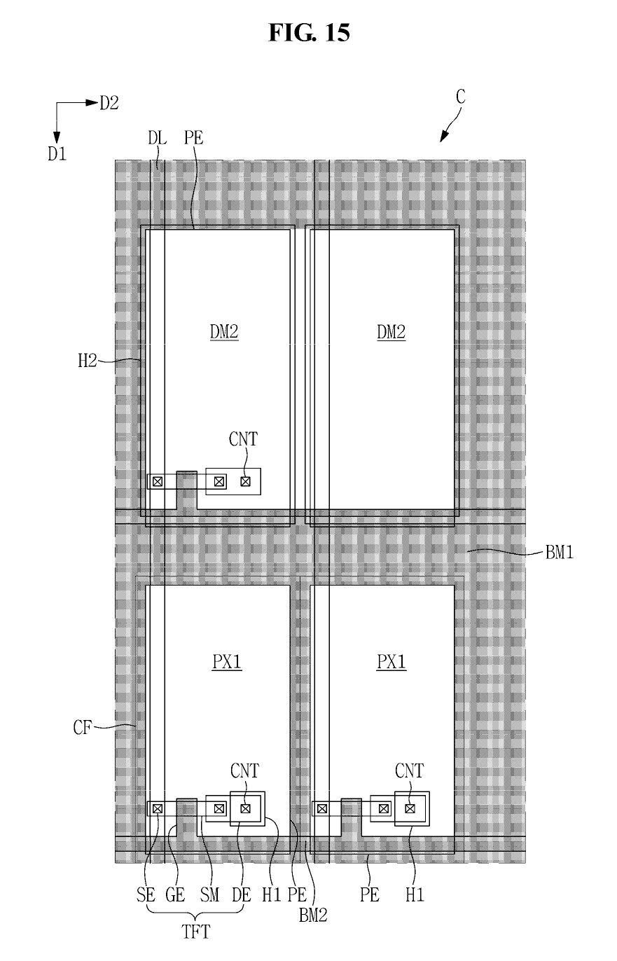

FIG. 14 is a plan view illustrating a reflective LCD device according to a sixth exemplary embodiment and FIG. 15 is an enlarged view illustrating an area “C” of FIG. 14.

The descriptions of the reflective LCD devices according to the first, second, third, fourth and fifth exemplary embodiments will be omitted from descriptions of the reflective LCD devices according to a sixth exemplary embodiment.

The reflective LCD device 106 according to a sixth exemplary embodiment includes a plurality of second dummy pixels DM2 which are second pixels PX2, and the plurality of second dummy pixels DM2 are disposed adjacent to each other on a plane. That is, a distance between the plurality of second dummy pixels DM2 may be substantially equal to or less than a distance between the plurality of first pixels PX1.

In addition, although not illustrated, the reflective LCD device 106 according to a sixth exemplary embodiment includes a bottom chassis accommodating an LCD panel including a first substrate 110, a second substrate 210 and a liquid crystal layer LC.

The second dummy pixel DM2 may display a gray level. For example, the second dummy pixel DM2 displays either a black gray level or a white gray level. Alternatively, the second dummy pixel DM2 may display a gray level.

The reflective layer 160 may have a first opening H1 and a second opening H2. The first opening H1 may be defined at an area corresponding to a contact hole CNT of the first pixel PX1 and the second opening H2 is defined at an area corresponding to the second dummy pixel DM2. Although not illustrated in the drawings, second openings H2 may include a plurality of second openings defined at areas respectively corresponding to the plurality of second dummy pixels DM2. However, exemplary embodiments are not limited thereto and the first opening H1 may have a planar area larger than a planar area of the contact hole CNT of the first pixel PX1.

According to a sixth exemplary embodiment, since an area at which the second dummy pixel DM2 is disposed does not include a reflective layer (not illustrated), a cell-gap may be measured even after an attachment process of the LCD panel. In addition, according to a sixth exemplary embodiment, the first black matrix BM1 has a second cut-out portion H_DM2 exposing at least one of the second dummy pixels DM2 and the bottom chassis 300 includes the reflective portion 310 at an area corresponding to the second dummy pixel DM2. Thus, the second dummy pixel DM2 may reflect an external light and may display an image based on a gray voltage applied to the second dummy pixel DM2.

In addition, according to a sixth exemplary embodiment, the reflective portion 310 of the bottom chassis 300 has a planar area substantially equal to or larger than a planar area of the second cutout portion H_DM2 of the first black matrix BM1 and substantially equal to or larger than a planar area of the second opening H2 of the reflective layer (not illustrated), to be described below. Thus, the display quality of the second dummy pixel DM2 may be improved.

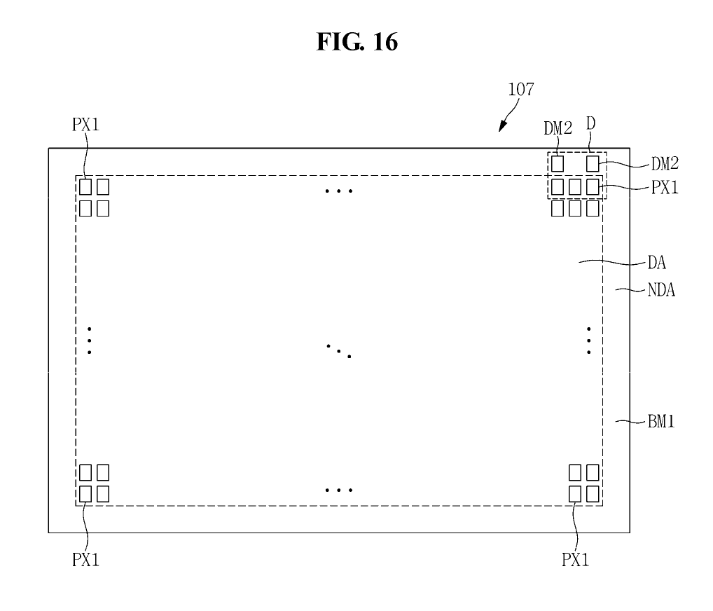

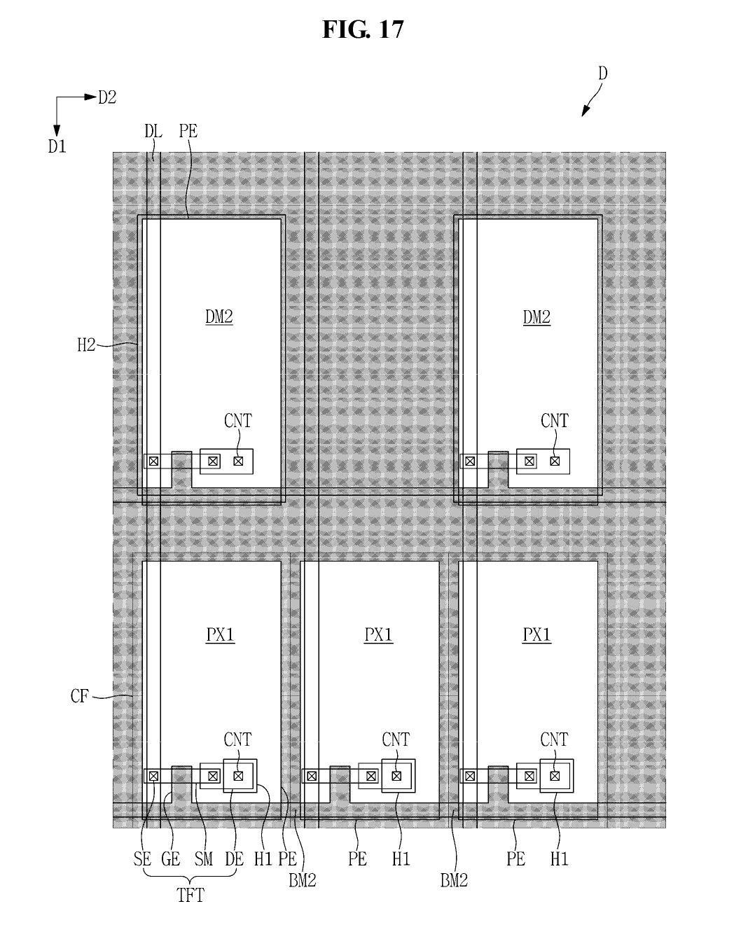

FIG. 16 is a plan view illustrating a reflective LCD device 107 according to a seventh exemplary embodiment and FIG. 17 is an enlarged view illustrating an area “D” of FIG. 16.

The descriptions of the reflective LCD devices according to the first, second, third, fourth, fifth, and sixth exemplary embodiments will be omitted from descriptions of the reflective LCD devices according to a seventh exemplary embodiment.

The reflective LCD device 107 according to a seventh exemplary embodiment includes a plurality of second dummy pixels DM2 which are the second pixels PX2, and the plurality of second dummy pixels DM2 are disposed spaced apart from each other on a plane. That is, a distance between the plurality of second dummy pixels DM2 may be larger than a distance between the plurality of first pixels PX1. In other words, a width of a first black matrix BM1 between the plurality of second dummy pixels DM2 may be larger than a width of a second black matrix BM2 between the plurality of first pixels PX1.

In addition, although not illustrated, the reflective LCD device 107 according to a seventh exemplary embodiment may include a bottom chassis accommodating an LCD panel including a first substrate 110, a second substrate 210 and a liquid crystal layer LC.

The second dummy pixel DM2 may represent a grayscale. For example, the second dummy pixel DM2 may display either a black grayscale or a white grayscale. On the other hand, the second dummy pixel DM2 may display a gray level.

According to a seventh exemplary embodiment, as illustrated in FIG. 15, the second dummy pixel DM2 may have a size substantially equal to a size of the first pixel PX1. Although not illustrated in the drawings, the second dummy pixel DM2 may have a size larger than a size of the first pixel PX1.

The reflective layer (not illustrated) may have a first opening H1 and a second opening H2. The first opening H1 may be defined at an area corresponding to a contact hole CNT of the first pixel PX1 and the second opening H2 may be defined at an area corresponding to the second dummy pixel DM2.

According to a seventh exemplary embodiment, an area at which the second dummy pixel DM2 is disposed does not include the reflective layer (not illustrated). Thus, a cell-gap may be measured even after an attachment process of the LCD panel. In addition, according to a seventh exemplary embodiment, the first black matrix BM1 has a second cut-out portion H_DM2 exposing at least one of the second dummy pixels DM2 and the bottom chassis 300 includes a reflective portion 310 at an area corresponding to the second dummy pixel DM2. Thus, the second dummy pixel DM2 may reflect an external light and may display an image based on a gray level voltage applied to the second dummy pixel DM2.

In addition, according to a seventh exemplary embodiment, the reflective portion 310 of the bottom chassis 300 has a planar area substantially equal to or larger than a planar area of the second cutout portion H_DM2 of the first black matrix BM1 and substantially equal to or larger than a planar area of a second opening H2 of the reflective layer (not illustrated). Thus, the display quality of the second dummy pixel DM2 may be improved.

As set forth hereinabove, in a reflective LCD device according to one or more exemplary embodiments, a cell-gap may be easily measured after an attachment process of an LCD panel by partially omitting a reflective layer.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A reflective liquid crystal display device, comprising:
a first substrate comprising a display area and a non-display area around the display area;
a second substrate opposing the first substrate;
a liquid crystal layer disposed between the first substrate and the second substrate; and
a plurality of pixels disposed on the first substrate,
wherein the plurality of pixels comprise:
a plurality of first pixels disposed on the display area and each of the plurality of first pixels comprising a reflective layer; and
at least one second pixel not comprising the reflective layer.

2. The reflective liquid crystal display device as claimed in claim 1, wherein the second pixel is disposed at an edge portion of the display area.

3. The reflective liquid crystal display device as claimed in claim 1, wherein the second pixel is disposed at a corner portion of the display area.

4. The reflective liquid crystal display device as claimed in claim 1, further comprising a black sheet disposed on a surface of the first substrate that does not face the second substrate,
wherein the black sheet overlaps the at least one second pixel.

5. The reflective liquid crystal display device as claimed in claim 1, wherein the at least one second pixel displays a black gray level.

6. The display device as claimed in claim 1, wherein each of the plurality of first pixels comprises:
the reflective layer disposed on the first substrate;
a color filter layer disposed on the reflective layer; and
a pixel electrode disposed on the color filter layer.

7. The reflective liquid crystal display device as claimed in claim 1, wherein the at least one second pixel is disposed at the non-display area.

8. The reflective liquid crystal display device as claimed in claim 7, wherein the at least one second pixel is disposed at an edge portion of the non-display area.

9. The reflective liquid crystal display device as claimed in claim 7, wherein the at least one second pixel is disposed at a corner portion of the non-display area.

10. The reflective liquid crystal display device as claimed in claim 7, further comprising a black matrix disposed to overlap the non-display area.

11. The reflective liquid crystal display device as claimed in claim 10, wherein the black matrix does not overlap the at least one second pixel.

12. The reflective liquid crystal display device as claimed in claim 10, wherein the black matrix has an opening defined at an area corresponding to the at least one second pixel.

13. The reflective liquid crystal display device as claimed in claim 7, further comprising a black sheet on a surface of the first substrate that does not face the second substrate,
wherein the black sheet overlaps the at least one second pixel.

14. The reflective liquid crystal display device as claimed in claim 7, wherein the at least one second pixel displays a black gray level.

15. The reflective liquid crystal display device as claimed in claim 7, further comprising a bottom chassis accommodating the first substrate, the second substrate, and the liquid crystal layer,
wherein the bottom chassis comprises a reflective portion which reflects an external light at an area corresponding to the at least one second pixel.

16. The reflective liquid crystal display device as claimed in claim 15, wherein the at least one second pixel displays a gray level.

17. The reflective liquid crystal display device as claimed in claim 16, wherein the at least one second pixel displays one of a black gray level or a white gray level.

18. The reflective liquid crystal display device as claimed in claim 15, further comprising a black matrix having a first cutout portion exposing at least one of the plurality of first pixels and a second cutout portion exposing the at least one second pixel,
wherein the reflective portion has a planar area substantially equal to or larger than a planar area of the second cutout portion on a plane.

19. The reflective liquid crystal display device as claimed in claim 18, wherein:
the at least one second pixel comprise a plurality of second pixels, and
a width of the black matrix between adjacent second pixels among the plurality of second pixels is larger than a width of the black matrix between adjacent first pixels among the plurality of first pixels.

20. The reflective liquid crystal display device as claimed in claim 15, wherein the reflective portion comprises a metal.
